(19) United States
(12) Patent Application Publication
(10) Pub. No.: US 2025/0317455 A1
(43) Pub. Date: Oct. 9, 2025

(54) Machine-Learned Suspicious Query Detection

(71) Applicant: CrowdStrike, Inc., Sunnyvale, CA (US)

(72) Inventors: Dor Agron, Zurich (CH); Michael Avraham Brautbar, Wayland, MA (US); Shaefer Drew, Lynnwood, WA (US); Avraham Kama, Be'er Ya'akov, IL (US); Asaf Lavi, Ramat Gan, IL (US); Sagi Sheinfeld, Ramat-Gan, IL (US); Yaron Zinar, Petah Tikva, IL (US)

(73) Assignee: CrowdStrike, Inc., Sunnyvale, CA (US)

(21) Appl. No.: 18/630,106

(22) Filed: Apr. 9, 2024

(51) Int. Cl. H04L 9/40

(52) U.S. Cl. CPC H04L 63/1425; H04L 63/1416

(57) ABSTRACT

A cybersecurity detection prediction service pre-screens database queries reported by endpoint client devices. The endpoint client devices may report the database queries to a cloud computing environment providing the cybersecurity detection prediction service. The endpoint client devices, however, may locally assess the database queries. The database queries are compared to a cybersecurity assessment profile generated by a machine learning model trained using endpoint cybersecurity detections. The cybersecurity detection prediction service thus provides a much faster cybersecurity prediction.

### BACKGROUND

The subject matter described herein generally relates to computers, to computer security, and to network security and, more particularly, the subject matter relates to endpoint detection and response (EDR), to malicious network traffic detection, and to event signature detection.

Cybersecurity attacks are always increasing. Nearly every day we read of another virus, hack, or malware. These cybersecurity attacks must be detected to avoid stolen, destroyed, or exposed information.

### SUMMARY

A cybersecurity detection prediction service pre-screens database queries associated with endpoint client devices. The endpoint client devices may report the database queries to a cloud computing environment providing the cybersecurity detection prediction service. The endpoint client devices, however, may locally assess the database queries. The database queries are compared to a cybersecurity assessment profile generated by a machine learning model trained using endpoint cybersecurity detections. The cybersecurity detection prediction service thus provides a much faster cybersecurity prediction.

### BRIEF DESCRIPTION OF THE SEVERAL VIEWS OF THE DRAWINGS

The features, aspects, and advantages of the cybersecurity service are understood when the following Detailed Description is read with reference to the accompanying drawings, wherein:

FIGS. 1-2 illustrate some examples of machine-learned suspicious query detection;

FIG. 3 illustrates examples of a cybersecurity assessment profile;

FIG. 4 illustrates more examples of cybersecurity prediction;

FIG. 5 illustrates more examples of a cybersecurity attack;

FIG. 6 illustrates still more examples of the cybersecurity attack;

FIG. 7 illustrates examples of endpoint cybersecurity detections;

FIG. 8 illustrates some examples of cybersecurity event signatures that may be flagged/detected as the endpoint cybersecurity detection;

FIGS. 9-11 illustrate some examples of an elegant morphological query analysis;

FIG. 12 illustrates some examples of localized analysis;

FIG. 13 illustrates examples of a method or operations that assesses the endpoint cybersecurity detection;

FIG. 14 illustrates more examples of a method or operations for assessing the endpoint cybersecurity detection;

FIG. 15 illustrates more examples of a method or operations for assessing the endpoint cybersecurity detections; and

FIG. 16 illustrates a more detailed example of an operating environment.

### DETAILED DESCRIPTION

Some examples relate to detection of cybersecurity attacks. As we all know, nearly every day there is another computer or network hack that steals account passwords and other personal information. Our inboxes often contain emails or texts that contain malicious links. Computer viruses can ruin our devices. A cybersecurity detection prediction service, however, protects computers and networks from cybersecurity attacks. The cybersecurity detection prediction service, in particular, detects or predicts cybersecurity attacks that use database queries as attack mechanisms. Some cybersecurity attackers may use database queries as reconnaissance techniques to covertly discover network targets, vulnerabilities, and attack vectors. Database queries may also be used to maliciously retrieve sensitive information, such as passwords, bank accounts, and other personal/proprietary data. The cybersecurity detection prediction service thus uses machine learning to discover database queries that precede or follow an endpoint cybersecurity detection within a specific timeframe (e.g., seconds, minutes, or hours). The cybersecurity detection prediction service may thus warn of, or even predict, cybersecurity attacks based on database queries.

Machine-learned suspicious query detection will now be described more fully hereinafter with reference to the accompanying drawings. Machine-learned suspicious query detection, however, may be embodied in many different forms and should not be construed as limited to the examples set forth herein. These examples are provided so that this disclosure will be thorough and complete and fully convey machine-learned suspicious query detection to those of ordinary skill in the art. Moreover, all the examples of machine-learned suspicious query detection are intended to encompass both structural and functional equivalents thereof. Additionally, it is intended that such equivalents include both currently known equivalents as well as equivalents developed in the future (i.e., any elements developed that perform the same function, regardless of structure).

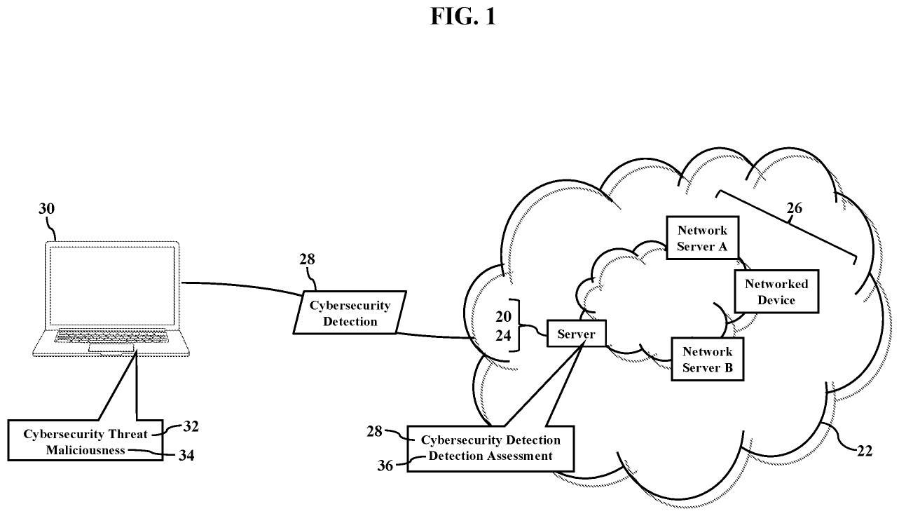

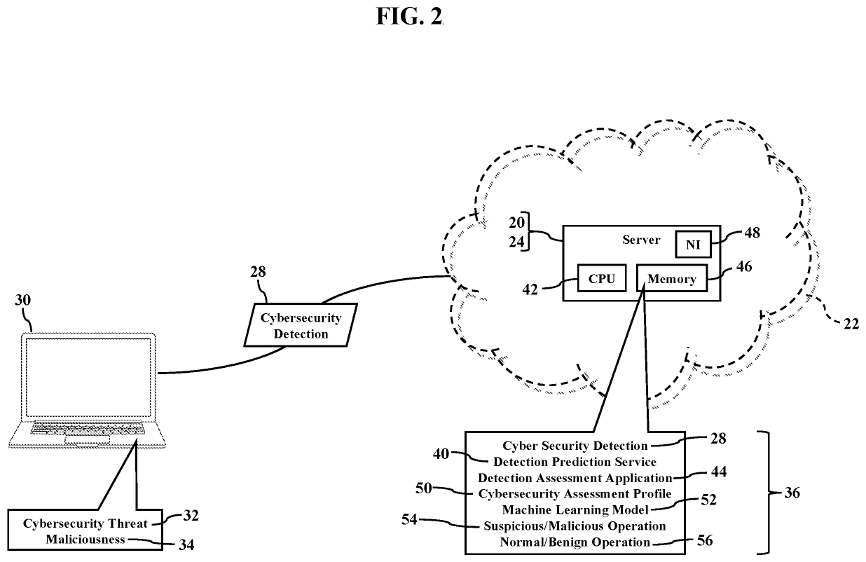

FIGS. 1-2 illustrate some examples of machine-learned suspicious query detection. A computer system 20 operates in a cloud computing environment 22. FIG. 1 illustrates the computer system 20 as a server 24. The computer system 20, though, may be any processor-controlled device, as later paragraphs will explain. In this example, the server 24 communicates via the cloud computing environment 22 (e.g., public Internet, private network, and/or hybrid network) with other servers, devices, computers, or other networked members 26 operating within, or affiliated with, the cloud computing environment 22. The server 24 is programmed to pre-screen or assess endpoint cybersecurity detections 28 reported by a client device 30 (illustrated, for simplicity, as a laptop computer system). That is, when the client device 30 detects suspicious behavior, unusual login/location context, or other potential cybersecurity threat 32 (as later paragraphs will explain in greater detail), the client device 30 sends the endpoint cybersecurity detection 28 to the cloud computing environment 22. The endpoint cybersecurity detection 28 alerts or notifies the cloud computing environment 22 that the client device 30 has detected the potential cybersecurity threat 32. The client device 30, in other words, has detected a program, process, communication, behavior, location, or some other evidence that may indicate maliciousness 34 (such as malicious behavior, usage, or software/malware). The client device 30 may then notify the cloud computing environment 22 for a fuller, more detailed detection assessment 36.

FIG. 2 illustrates some examples of the detection assessment 36. When the cloud computing environment 22 receives the endpoint cybersecurity detection 28, the cloud computing environment 22 may route the endpoint cybersecurity detection 28 to the server 24 for the detection assessment 36. The server 24 may thus provide a cloud-based cybersecurity detection prediction service 40 to the networked members 26 operating within, or affiliated with, the cloud computing environment 22. The server 24 may also provide the cloud-based cybersecurity detection prediction service 40 to other clients (such as the client device 30). The server 24 has at least one hardware processor 42 (illustrated as “CPU”) that executes a detection assessment application 44 stored in a memory device 46. The server 24 also has network interfaces (illustrated as “NI”) 48 to multiple communications networks (such as the cloud computing environment 22), thus allowing bi-directional communications with networked devices. When the server 24 receives the endpoint cybersecurity detection 28, the detection assessment application 44 may be a computer program, instruction(s), or code that instructs or causes the server 24 to preliminarily assess the endpoint cybersecurity detection 28.

The server 24 performs the fast and effective cybersecurity detection prediction service 40. When the server 24 receives the cybersecurity detection 28, the server 24 executes the detection assessment application 44 as a predictor engine. The server 24 may ingest the cybersecurity detection 28 as an input, and the detection assessment application 44 instructs the server 24 to compare the endpoint cybersecurity detection 28 to a cybersecurity assessment profile 50 generated by a machine learning model 52. The cybersecurity assessment profile 50 may statistically define or specify process events, communications, activities, behaviors, data values, patterns, contextual login/location, or other electronic content that have been assessed as suspicious or even malicious operation 54. The cybersecurity assessment profile 50 may additionally or alternatively statistically define or specify process events, communications, activities, behaviors, data values, patterns, contextual login/location, or other electronic content that have been assessed as safe/normal/benign operation 56. The cybersecurity assessment profile 50, in other words, may describe suspect/threatening/normal/harmless behaviors, identities, locations, or other data. The cybersecurity assessment profile 50 may thus represent historical confirmations or observations of information, data, bits/bytes, and/or other electronic content that is/are known to indicate suspicious or even malicious operation 54. The cybersecurity assessment profile 50 may additionally or alternatively represent historical confirmations or observations of information, data, bits/bytes, and/or other electronic content that is/are known to indicate safe or normal operation 56. Whatever information or data is described by, or included with, the cybersecurity detection 28, that information or data may be compared to the cybersecurity assessment profile 50. If the electronic content represented by the cybersecurity detection 28 equals, matches, satisfies, lies within, or conforms to the cybersecurity assessment profile 50, then the detection assessment application 44 may determine that the cybersecurity detection 28 is the suspicious/malicious operation 54 or the normal/benign operation 56.

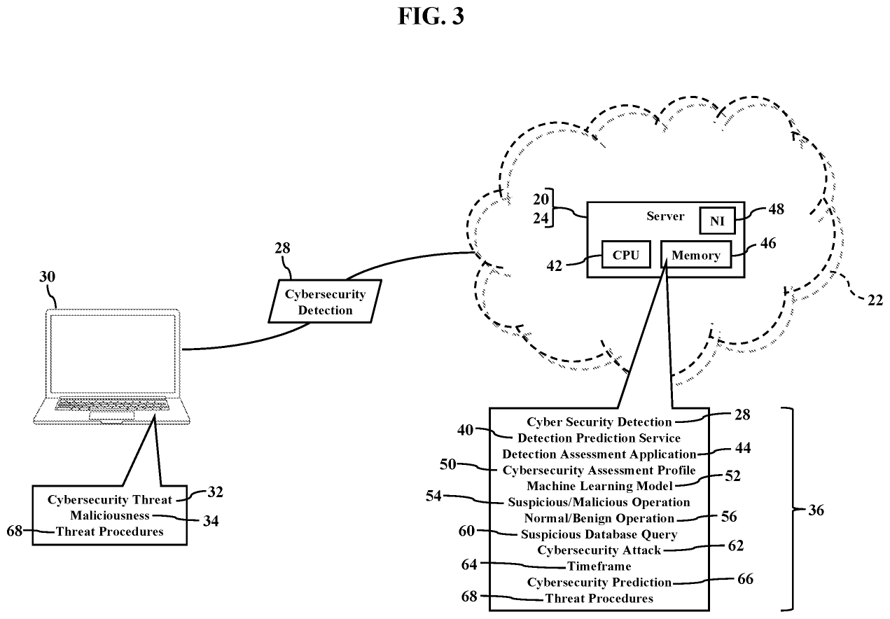

FIG. 3 illustrates examples of the cybersecurity assessment profile 50. The cybersecurity assessment profile 50 may statistically identify the suspicious/malicious operation 54. Because the machine learning model 52 builds the cybersecurity assessment profile 50, the machine learning model 52 may statistically predict a range of the suspicious or even malicious operation 54. The cybersecurity assessment profile 50, in other words, may specify names, processes, and/or values that describe ranges of the suspicious/malicious operation 54, such as terms defining abnormal or unexpected process events, communications, activities, behaviors, data values, patterns, contextual login/location, or other electronic content. The cybersecurity assessment profile 50, as an example, may describe suspicious database queries 60. The inventors have discovered that some cybersecurity attacks 62 utilize one or more suspicious database queries 60 as attack mechanisms. When a communications network, for example, is compromised, attackers may use the suspicious database queries 60 as reconnaissance techniques to covertly discover network targets, vulnerabilities, and attack vectors. Indeed, the suspicious database query 60 may precede or follow the endpoint cybersecurity detection 28 within a specific timeframe 64. The timeframe 64 may have a length or start/stop (e.g., seconds, minutes, hours, or longer). The timeframe 64, for example, may be one (1) hour (e.g., 60 minutes). If the endpoint cybersecurity detection 28 precedes or follows the database query 60 within the timeframe 64, then the cybersecurity assessment profile 50 may indicate that the endpoint cybersecurity detection 28 and/or the database query 60 lies outside the range(s) of the normal/benign operation 56. The cybersecurity assessment profile 50, in other words, may indicate the suspicious/malicious operation 54.

The server 24 may generate a cybersecurity prediction 66. When data associated with the current endpoint cybersecurity detection 28 and/or the database query 60 conforms to the cybersecurity assessment profile 50, the detection assessment application 44 may thus instruct the server 24 to determine the endpoint cybersecurity detection 28 and/or the database query 60 is the suspicious/malicious operation 54. The server 24 may thus generate the cybersecurity prediction 66 as an output, and the cybersecurity prediction 66 determines, or predicts, that the endpoint cybersecurity detection 28 and/or the database query 60 is suspicious/malicious operation 54. That is, the cybersecurity assessment profile 50 reveals the endpoint cybersecurity detection 28 and/or the database query 60 to be abnormal or harmful processes, behaviors, identities, locations, or other data when concurrently observed within the timeframe 64. The detection assessment application 44 may further instruct the server 24 to label, sort, or classify the endpoint cybersecurity detection 28 and/or the database query 60 as a true positive report of the cybersecurity attack 62. The detection assessment application 44 may further instruct the server 24 to implement notification/quarantine/isolation/halt or other urgent threat procedures 68. The detection assessment application 44 may additionally or alternatively instruct the client device 30 to implement the notification/quarantine/isolation/halt or other urgent threat procedures 68. The detection assessment application 44 may also hand-off and queue the endpoint cybersecurity detection 28 and/or the database query 60 for a deeper analysis (such as a human analyst review by cybersecurity subject matter experts). Because the endpoint cybersecurity detection 28 and/or the database query 60 has been screened and preliminarily assessed as the suspicious/malicious operation 54, the detection assessment application 44 may route the endpoint cybersecurity detection 28 and/or the database query 60 to a human expert or group of human experts for an urgent, deep-dive analysis.

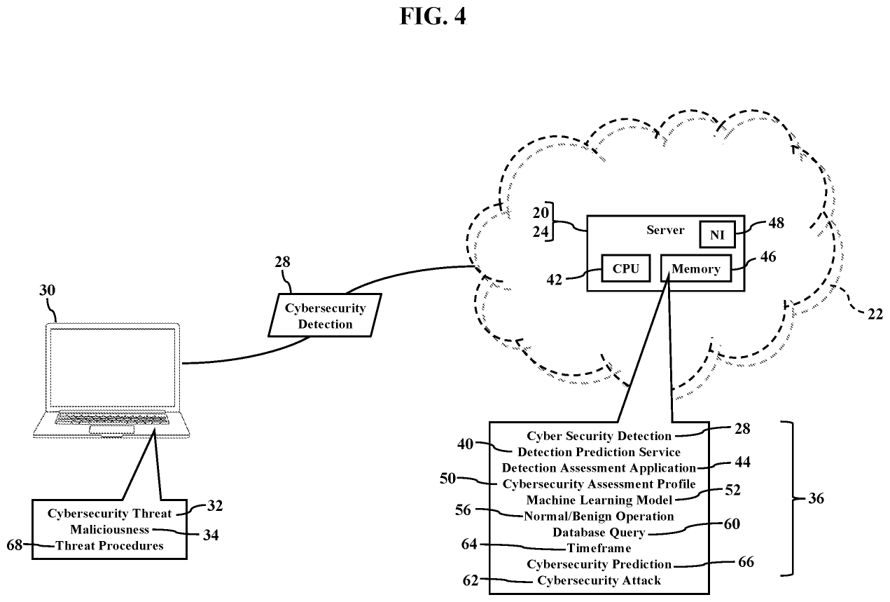

FIG. 4 illustrates more examples of the cybersecurity prediction 66. The cybersecurity assessment profile 50 may statistically identify the normal/benign operation 56. Because the machine learning model 52 builds the cybersecurity assessment profile 50, the machine learning model 52 may additionally or alternatively statistically predict a range of the normal/benign operation 56. The cybersecurity assessment profile 50, in other words, may specify names, processes, and/or values that describe ranges of the normal/benign operation 56, such as terms defining normal or expected process events, communications, activities, behaviors, data values, patterns, contextual login/location, or other electronic content. The cybersecurity assessment profile 50, as another example, may describe common or ubiquitous database queries 60. So, even if the database query 60 precedes or follows the endpoint cybersecurity detection 28, within or outside the timeframe 64, then the cybersecurity assessment profile 50 may indicate that the endpoint cybersecurity detection 28 and/or the database query 60 is the normal/benign operation 56. The server 24 may thus generate the cybersecurity prediction 66 as normal/benign operation 56. The detection assessment application 44 may further instruct the server 24 to label, sort, or classify the endpoint cybersecurity detection 28 and/or the database query 60 as a false positive report of the cybersecurity attack 62. The endpoint cybersecurity detection 28 and/or the database query 60 may be, but not always, a false alarm.

Computer functioning is greatly improved. Malicious software can ruin computer operations. The server 24 must quickly identify the suspicious/malicious operation 54 to minimize damage to the client computers 30. Because the detection assessment application 44 utilizes the machine learning model 52, the cloud-based cybersecurity detection prediction service 40 is very fast and very simple to execute. The server 24 need merely compare the endpoint cybersecurity detection 28 and/or the database query 60 to the cybersecurity assessment profile 50. The cybersecurity assessment profile 50 consumes little space (in bits/bytes) in the memory device 46. Moreover, because comparisons may be simple logical statements, the hardware processor 42 requires less cycles and less time to classify the endpoint cybersecurity detection 28 and/or the database query 60. Computer resources are reduced, and less electrical power is required to test for presence of the suspicious/malicious operation 54. The cloud-based cybersecurity detection prediction service 40 is thus very fast and very simple, allowing the server 24 to quickly assess millions or trillions of the endpoint cybersecurity detections 28 and/or the database queries 60 reported each week. The cloud-based cybersecurity detection prediction service 40 thus greatly improves computer functioning of the server 24 when detecting the suspicious/malicious operation 54.

The cloud-based cybersecurity detection prediction service 40, as more examples, may utilize timestamps. The endpoint cybersecurity detection 28 may be associated with a detection timestamp. The database query 60 may be associated with a query timestamp. If the server 24 executing the detection assessment application 44 determines that the detection timestamp lies within the timeframe 64 (e.g., 60 minutes preceding or succeeding) of the query timestamp, then the detection assessment application 44 may generate the cybersecurity prediction 66 that the suspicious/malicious operation 54, and/or the cybersecurity attack 62, has been discovered. If the detection assessment application 44 detects the database query 60 within an hour succeeding the endpoint cybersecurity detection 28, then the detection assessment application 44 may additionally or alternatively generate the cybersecurity prediction 66 that the suspicious/malicious operation 54, and/or the cybersecurity attack 62, has been discovered.

Mutual detections may be noted. The cybersecurity detection prediction service 40 may monitor, inspect, and compare the database queries 60 and the endpoint cybersecurity detections 28 for mutual occurrences within the timeframe 64. When the detection assessment application 44 determines that the database query 60 and the endpoint cybersecurity detection 28 occurred within the timeframe 64 (as referenced by the cybersecurity assessment profile 50), then the detection assessment application 44 may generate the cybersecurity prediction 66 of the suspicious/malicious operation 54 and/or the cybersecurity attack 62. Whatever the timeframe 64, the detection assessment application 44 may further instruct the client device 30 to block the events representing the database query 60 and/or the endpoint cybersecurity detection 28, thus thwarting the cybersecurity attack 62.

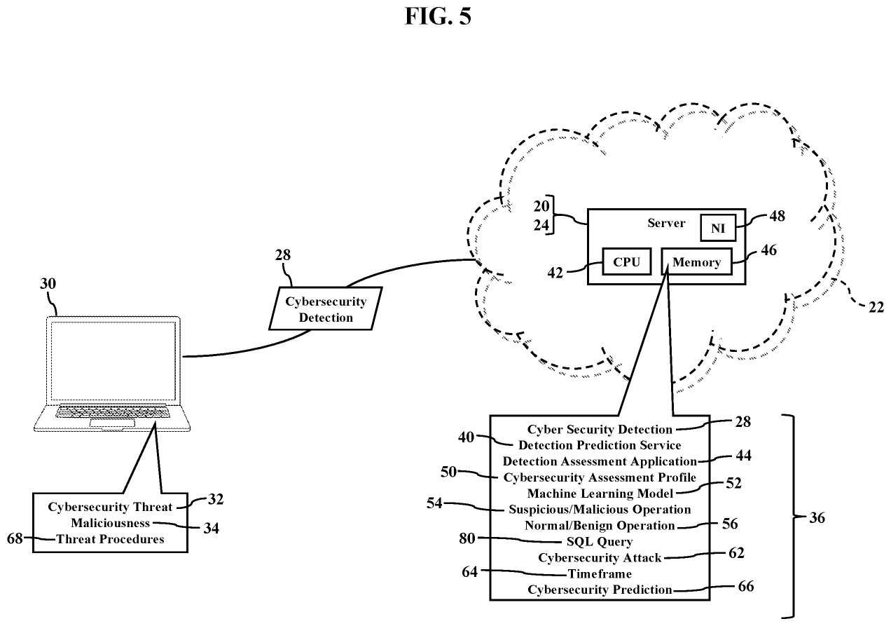

FIG. 5 illustrates more examples of the cybersecurity attack 62. The database query 60 may be evidence of the cybersecurity attack 62. As FIG. 5 illustrates, for example, the database query 60 may be a version of a structured query language (or SQL) query 80. The SQL query 80 is a programming language for accessing and manipulating databases. The cybersecurity assessment profile 50 may thus be trained using SQL queries 80 that are labeled or classified as the suspicious/malicious operation 54. The cybersecurity assessment profile 50 may additionally or alternatively be trained using SQL queries 80 that are labeled or classified as the normal/benign operation 56. The cybersecurity assessment profile 50 may additionally or alternatively be trained using the endpoint cybersecurity detection 28 that are labeled or classified as the suspicious/malicious operation 54 and/or as the normal/benign operation 56. When the server 24 receives the endpoint cybersecurity detection 28 and/or the database query 60, the detection assessment application 44 may compare the endpoint cybersecurity detection 28 and/or the database query 60 to the cybersecurity assessment profile 50 and generate the cybersecurity prediction 66 of the suspicious/malicious operation 54 or the normal/benign operation 56.

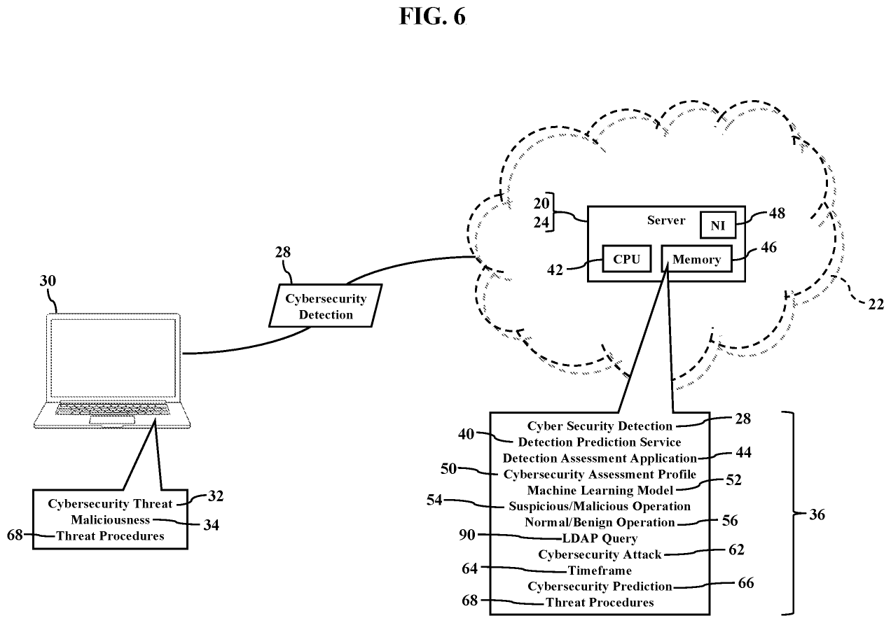

FIG. 6 illustrates still more examples of the cybersecurity attack 62. FIG. 6 illustrates another example of the database query 60 as a lightweight directory access protocol (or LDAP) query 90. Hackers often exploit an active directory (or AD) to access user accounts and, thus, communications networks (such as the cloud computing network 22). The LDAP protocol allows users to query and modify active directory data. While modifications to the active directory data may require administrative privileges, all active directory users can read all directory active directory data by default. This read default makes LDAP a common target for reconnaissance attacks following an initial compromise of a network. The detection assessment application 44 may thus flag suspicious LDAP queries 90 that could be considered reconnaissance attempts. If the detection assessment application 44 determines that event(s) representing the LDAP query 90 occurs/occur within the timeframe 64 of the endpoint cybersecurity detection 28, then the detection assessment application 44 may generate the cybersecurity prediction 66 of the suspicious/malicious operation 54. The detection assessment application 44 may further implement the threat procedures 68 and even instruct the client device 30 to block the hardware/software events representing the endpoint cybersecurity detection 28 and/or the LDAP query 90.

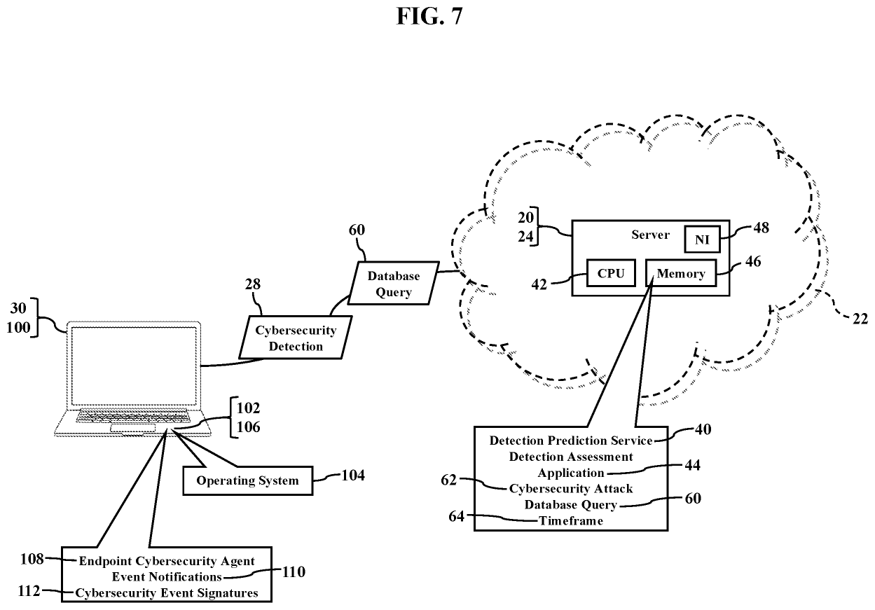

FIG. 7 illustrates examples of the cybersecurity detection prediction service 40. The server 24 is programmed to pre-screen or assess the endpoint cybersecurity detections 28 and/or the database queries 60 reported by the client device 30. FIG. 7, for simplicity, again illustrates the client device 30 as the laptop computer system 100. The client device 30, though, may be any processor-controlled device, as later paragraphs will explain. The laptop computer system 100 has a hardware processor 102 that executes an operating system 104 stored in a memory device 106. The operating system 104 controls and manages all the hardware and software resources available to the client device 30. The client device 30, however, also stores an endpoint cybersecurity agent 108 in the memory device 106. The endpoint cybersecurity agent 108 registers with the operating system 104 to receive event notifications 110 detailing hardware and software events requested of the operating system 104. The operating system 104 may send the event notifications 110 to the endpoint cybersecurity agent 108 and then await an approval or denial. When the endpoint cybersecurity agent 108 receives the event notifications 110, the endpoint cybersecurity agent 108 compares the event notifications 110 to cybersecurity event signatures 112. The cybersecurity event signatures 112 describe or reference the hardware/software events that are categorized or defined as suspicious and reportable. If the hardware/software events match any of the cybersecurity event signatures 112, then the endpoint cybersecurity agent 108 generates and sends the endpoint cybersecurity detection 28 to the cloud computing environment 22 for the detection prediction service 40. The endpoint cybersecurity detection 28 describes or references the hardware/software events that matched any of the cybersecurity event signatures 112. The cybersecurity event signatures 112 may also describe or reference the hardware/software events associated with the database query 60. The endpoint cybersecurity agent 108 may thus also report the database query 60 to the cloud computing environment 22 for the detection prediction service 40.

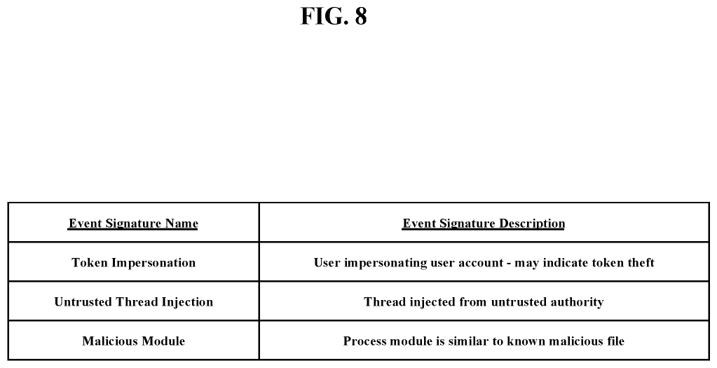

FIG. 8 illustrates some examples of descriptions of the cybersecurity events for which cybersecurity event signatures 112 may be flagged/detected by the cybersecurity detection prediction service 40. The descriptions of cybersecurity event signatures 112 may be stored in the memory device 106 of the client device 30, and the endpoint cybersecurity agent 108 compares the events (perhaps as described by the event notifications 110 from the operating system 104) to the cybersecurity event signatures 112. While the endpoint cybersecurity agent 108 may monitor for patterns or occurrences of the events, FIG. 8 illustrates some examples of descriptions of the cybersecurity event signatures 112. Each cybersecurity event signature 112 may be identified using a general pattern name 120 and/or a pattern description 122. Whatever the general pattern name 120 and/or the pattern description 122, the cybersecurity event signature 112 has been found to be evidence of the cybersecurity attack 62, especially when logged/recorded in conjunction with the database query 60 within the timeframe 64. The actual events representing each cybersecurity event signature 112 may vary, yet the general pattern name 120 and/or the pattern description 122 generally describes the attack mechanism. The cybersecurity event signatures 112 that may be flagged/detected as the cybersecurity endpoint detections 28 may be expressed/flagged/categorized/filtered as high, medium, and low confidence. Some cybersecurity event signatures 112 may be considered higher efficacy, and/or some cybersecurity event signatures 112 may relate more to LDAP enumeration. The endpoint cybersecurity detections 28 may be time proximate (e.g., within the timeframe 64) of the database query 60.

Event logs may be monitored. There are many sources that log the database queries 60 and/or the hardware and software events for analysis. For example, the endpoint cybersecurity agent 108 may access an event channel that provides event behaviors. The endpoint cybersecurity agent 108 may additionally or alternatively read an event log file, a trace file, and/or a real-time event tracing session. The endpoint cybersecurity agent 108 may register for, or subscribe to, logged or real-time event behaviors (such as the event notifications 110). The detection assessment application 44 may additionally or alternatively access an event channel, read an event log file, read a trace file, and/or read a real-time event tracing session. The detection assessment application 44 may register for, or subscribe to, logged or real-time event behaviors (such as the event notifications 110). Whatever the event source, the event source may be a local resource (such as stored in the client device 30) and/or a remote networked resource accessed via a communications network (such as the cloud computing environment 22). Regardless, the event source may be queried/read to identify event behaviors of interest (e.g., provider/source, EventID, timestamp). The endpoint cybersecurity agent 108, for example, may thus log, store, and/or retrieve current/historical records of the database queries 60 associated with a user of the laptop computer system 100.

The cybersecurity detection prediction service 40 thus provides an elegant solution. The cybersecurity detection prediction service 40 implements a layered approach to suspicious query detection. The cybersecurity detection prediction service 40 provides signature-based detection for suspicious database queries 60. The cybersecurity detection prediction service 40, for example, detects specific signatures in LDAP and creates detections for those. The cybersecurity detection prediction service 40, however, also integrates machine learning. The cybersecurity detection prediction service 40 inspects for the LDAP queries 90 by monitoring the client device 30 or process (e.g., the cybersecurity attack 62) that originated the LDAP query 90. The cybersecurity detection prediction service 40, however, also uses time proximity (e.g., the timeframe 64) data on the machine or process to label the LDAP query 90 as malicious or not malicious. The cybersecurity detection prediction service 40 monitors for concurrent endpoint cybersecurity detections 28 (such as, for example, ransomware, malware, APT, or other attack mechanism). The cybersecurity detection prediction service 40 may then assume or conclude that a previous/succeeding LDAP query 90 (originating from that same endpoint client device 30) is also malicious. These suspicious observations may be used as labels for the supervised machine learning on LDAP query requests. The cybersecurity detection prediction service 40 thus leverages the endpoint cybersecurity detections 28, the client/user/endpoint identity, network analysis, and morphological analysis to improve computer functioning and to detect the cybersecurity attack 62.

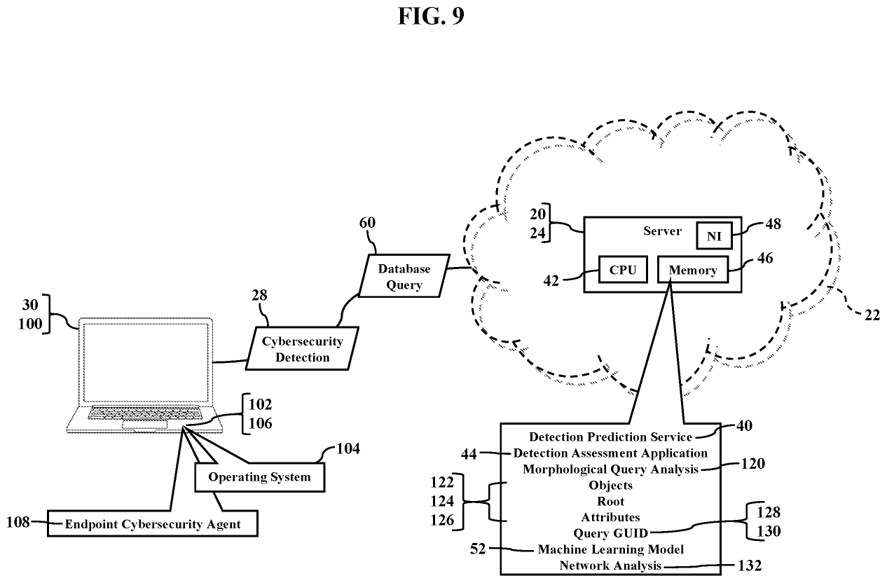

FIGS. 9-11 illustrate some examples of an elegant morphological query analysis 120. The cybersecurity detection prediction service 40 may gather/collect extensive data describing each database query 60. The cybersecurity detection prediction service 40, for example, may inspect and analyze each database query 60 for its associated features and values. For example, the detection assessment application 44 may determine how many objects 122 were requested, what was the root 124 of the request, and/or what attributes 126 were requested. The cybersecurity detection prediction service 40 may then use this information to create a database query signature 128 (illustrated as a globally unique identifier or GUID 130) for that requested database query 60. The detection assessment application 44 may retrieve the data describing the database query 60 from the cloud computing environment 22 and/or from the endpoint cybersecurity agent 108 cooperating with the operating system 104. The cybersecurity detection prediction service 40, for example, may cryptographically hash (using a hashing algorithm) the features and values (such as the database query 60, the objects 122 requested, the root 124, and/or the attributes 126) to generate the database query signature/GUID 128/130. The cybersecurity detection prediction service 40 may then train the machine learning (e.g., the machine learning model 52) using the database query signature/GUID 128/130, network analysis 132, and the endpoint cybersecurity detections 28 to annotate network/database requests based on endpoint data. The cybersecurity detection prediction service 40 thus creates the machine learning model 52 to detect the malicious database queries 60.

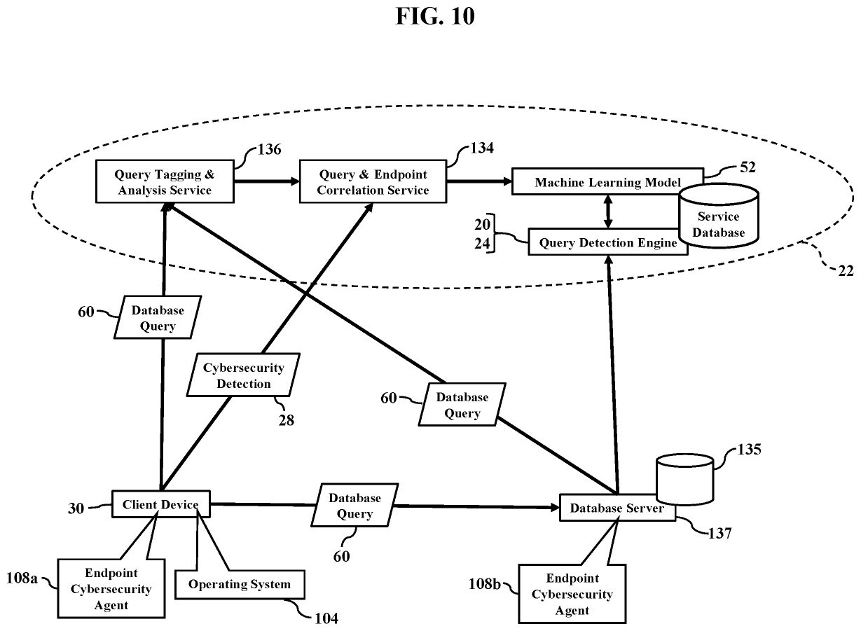

FIG. 10 illustrates examples of a distributed architecture. The client device 30 loads and installs an instance of the endpoint cybersecurity agent (illustrated as reference numeral 108a). As the client device 30 receives electrical power and operates, the endpoint cybersecurity agent 108a cooperates with the operating system 104 to send the cybersecurity detections 60 to the cloud computing environment 22. When the endpoint cybersecurity agent 108a detects a suspicious behavior, unusual login/location context, or other potential cybersecurity threat (such as examples of the cybersecurity event signatures 112 illustrated in FIG. 8), the client device 30 sends the endpoint cybersecurity detection 28 to the cloud computing environment 22. The cloud computing environment 22 may then route the endpoint cybersecurity detection 28 to a networked member performing a query and endpoint correlation service 134. The endpoint cybersecurity agent 108a may also cooperate with the operating system 104 to detect the database query 60 that requests a query of a database 135. When the endpoint cybersecurity agent 108a detects the database query 60, the endpoint cybersecurity agent 108a may intercept and send the database query 60 to the cloud computing environment 22. The cloud computing environment 22 may then route the database query 60 to a networked member performing a query tagging and analysis service 136. The database query 60, however, may also be intercepted at a database server 137 managing the database 135. The database server 137, for example, may also store, install, and execute another instance of the endpoint cybersecurity agent (illustrated as reference numeral 108b). When the database server 137 receives the database query 60 sent by the client device 30, the endpoint cybersecurity agent 108b may intercept and send the database query 60 to the cloud computing environment 22 for routing to the query tagging and analysis service 136. The query and endpoint correlation service 134 and the query tagging and analysis service 136 may thus interface to map, relate, associate, or otherwise bind the endpoint cybersecurity detection 28 to the database query 60. The cloud computing environment 22, for example, determines that the endpoint cybersecurity detection 28 and the database query 60 both originated from the same client device 30. As an example, the endpoint cybersecurity detection 28 and the database query 60 may both be associated with the same endpoint cybersecurity agent 108a operating in the client device 20. As another example, the database query 60 may be sent from the endpoint cybersecurity agent 108a, but the database query 60 originated from the endpoint cybersecurity agent 108a. The query and endpoint correlation service 134 and the query tagging and analysis service 136 may thus use network/IP addresses (perhaps revealed by packet header information) to analyze and to correlate the endpoint cybersecurity detection 28 and the database query 60 with the same originating endpoint cybersecurity agent 108a and/or the client device 20.

The cloud computing environment 22 may thus interface with different computer systems. The client device 20, for example, may alert the cloud computing environment 22 of the endpoint cybersecurity detection 28. The database server 137 (managing the database 135) may alert the cloud computing environment 22 of the database query 60. The cloud computing environment 22 may then invoke the query and endpoint correlation service 134 and/or the query tagging and analysis service 136 to correlate the endpoint cybersecurity detection 28 with the database query 60. The cloud computing environment 22 may thus bind the client device 30 (e.g., perhaps both the detecting machine and the querying machine) to the endpoint cybersecurity detection 28 and the database query 60. The database server 137, however, may also be another machine from which the attacker wishes to query data (e.g., the database query 60). The endpoint cybersecurity agent 108b may thus capture the database query 60 at the database server 137. The endpoint cybersecurity agent 108b, for example, may inspect and monitor service logs associated with the database server 137 and/or the database 135. The endpoint cybersecurity agents 108a-b, as another example, may detect the database query 60 by monitoring/intercepting the network interface. The endpoint cybersecurity agents 108a-b may thus intercept and forward raw data representing the endpoint cybersecurity detection 28 and the database query 60 to the cloud computing environment 22.

The cloud computing environment 22 thus processes the endpoint cybersecurity detection 28 and the database query 60. The cloud computing environment 22 may correlate the endpoint cybersecurity detection 28 and the database query 60 using the query and endpoint correlation service 134 and/or the query tagging and analysis service 136. The cloud computing environment 22, for example, parses and analyzes the database queries 60. The cloud computing environment 22 correlates the endpoint cybersecurity detections 28 and the database queries 60 in order to label the machine learning model 52. The cloud computing environment 22 trains the machine learning model 52 using the labeled database queries 60. Once the machine learning model 52 is then trained, the cloud computing environment 22 may analyze future database queries 60, in near real time, using the machine learning model 52 to generate the cybersecurity prediction 66.

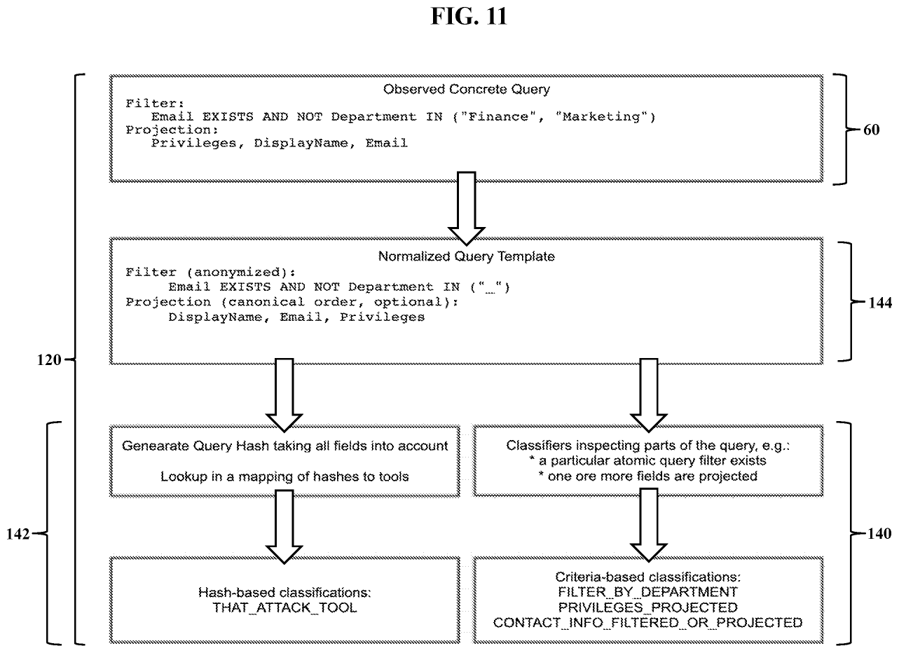

FIG. 11 illustrates more examples of the morphological query analysis 120. The morphological query analysis 120 elegantly classifies the database query 60. Indeed, the morphological query analysis 120 may use multiple classification mechanisms. A first classification mechanism 140, for example, may classify the database query 60 using classification tags. A second classification mechanism 142, as another example, may classify the database query 60 using hashing techniques. The morphological query analysis 120 may thus elegantly classify the database query 60 using the first classification mechanism 140 and/or the second classification mechanism 142.

As the above paragraphs explained, the cybersecurity detection prediction service 40 may classify the database query 60 regardless of an interface terminology. While data query interfaces (such as various variants of SQL and LDAP) may have differences, many concepts are common between the database queries 60. For example, for most practical purposes, SQL fields are completely analogues to LDAP attributes. A document returned by a NoSQL DB server is quite similar to SQL rows. The cybersecurity detection prediction service 40 may thus set aside and/or disregard a particular interface terminology. The cybersecurity detection prediction service 40 may define and utilize a conceptual common ground, and a common terminology, of the data query interface to which the morphological query analysis 120 is applied. The cybersecurity detection prediction service 40 may thus classify the SQL query 80, the LDAP query 90, and other database queries 60 using other interface terminologies (such as, for example, documented-oriented NoSQL databases).

Queries going through such data query interfaces are characterized by a few dimensions. A common query dimension, for example, may be a query filter. The query filter may be criteria determining which whole-entry (a row in SQL, an entry in LDAP, a document in many NoSQL databases, etc.) are relevant for the consumer. For example, given a typical customer dataset, a country=′USA′ SQL filter would match customers from the USA, whereas an age>30 SQL filter would match customers older than the specified age. Most query interfaces allow composite filters combining two or more of query filters with a logical operand. For example, the query filters country=′USA′ AND age>30 and country=′USA′ OR age>30 both combine the two previous examples, each to a single new query filter, but with different likely outcome: the first likely to match less documents than each “sub” filter on its own, and the later to match more documents than its filter on its own. The composite nature of query filters is often recursive (that is, a filter may be composed of already-composite filters). The cybersecurity detection prediction service 40, and/or the morphological query analysis 120, may designate or define a simple, non-composite query filter an atomic query filter (as opposed to a composite filter). While the syntax and mechanics may vary between implementations, conceptually, a typical atomic query filter consists of three elements: a field name, a binary operator and a filter value, e.g., [field-name: age, operator: >, value: 35] for an age-filter example. However, unary atomic query filters are also quite common. For example, many data query interfaces allow querying for the presence or existence of a field (e.g., the textual-form (cn=*) LDAP query filter means “match entries which have a cn field containing any value whatsoever”). More generally, an atomic filter consists of a filed name, an N-arity operator and N−1 filter-values. This differentiation between these parts may be used as an anonymization process (as later paragraphs will explain).

Another common query dimension may be a projection. The projection is a set of field names (sometimes called attributes) to be included in the query result from those records that matched the query filter. Many query interfaces also allow a select-all-fields projections (e.g., SELECT * in SQL).

The query filter and the query projection are some of the most elementary and common query dimensions. The query filter and the query projection may thus be significant to query classification. Still, though, each query interface has its own particularities, and some particularities may be of importance to the query semantics leading to completely different selection set (e.g., a combination of order-by and limit in SQL, or the LDAP “search scope”). The cybersecurity detection prediction service 40, and/or the morphological query analysis 120, may thus be configured and/or adapted to use the particularities of query semantics as desired.

Data queries, whether issued programmatically or by a human being writing them manually, often echo what a query consumer wishes to find out. For instance, consider the shopping backend for a shopping website: if the cybersecurity detection prediction service 40, and/or the morphological query analysis 120, determines the database query 60 for products filtering on a category field and projecting just a few attributes, it is likely in use for a product list page, allowing to filter by category. On the other hand, the database query 60 for a product by its id, projecting many or all of its attributes, is likely associated with an item-details page.

To put it another way, if the cybersecurity detection prediction service 40, and/or the morphological query analysis 120, determines the data schema (what is in the data set, what fields are available, etc.), an observed database query 60 may echo its use case to some extent. Each of the query dimensions (query filter, projection, etc.) can provide some hints. Moreover, when the database query 60 is issued by a tool (such as an attack software tool), the database query 60 is often a very reliable signature for the tool used (and in the attack use case, that an attack attempt may have occurred).

However, even when a tool is used, queries by their nature are often not completely static. For example, if an attack tool attempts to lookup the group membership of some user, an id of the user (e.g., samAccountName or objectSid in AD) is likely to show up in the query. What is static is the query shape, or template—a canonical version of it, which has blanks, or placeholders, in place of data pieces associated with particular entries, such as user names or product ids.

The morphological query analysis 120 may thus elegantly use multiple classification mechanisms. The first classification mechanism 140, for example, may be dynamic, suited for the database query 60 in the subject domain, and is based on inspection of the query data. For example, if the query filter includes a simple equality filter over a unique-identifier field (a key field), the morphological query analysis 120 may determine that the database query 60 intends to query data of a single specific entry. On the other hand, if the database query 60 does not contain such a filter, then the database query 60 may be more likely to be associated with an enumeration of entries.

The first classification mechanism 140 may classify by running the database query 60 against a set of predicate-defined classification tags. A predicate may inspect any dimension of the database query 60. For example, the first classification mechanism 140 may check that certain fields are projected, or that a particular filed is used in a filter with a certain operator, or with any operator, or that a complete filter exists as part of the normalized filter. Predicates can also be composed together such that, for example, a particular combination of a filter and projection is required for the predicate to match. Predicates are also not limited to these dimensions and may refer to interface-specific dimensions (e.g., require a specific LDAP search scope).

The second classification mechanism 142 may utilize hashing techniques. The second classification mechanism 142, as another example, may rely on creating a predictable hash value (such as the query GUID 128 and 130) using the hashing algorithm for a query template 144 as a whole (rather than for original query). While the cybersecurity detection prediction service 40, and/or the morphological query analysis 120, may use any hashing algorithm, the MD5 and MD7 hashing algorithms may be used to generate the query GUID 128 and 130 based on the database query 60. Later paragraphs will describe generation of the intermediate query template 144. Stable hashes of attack tools can then be predetermined and set to trigger detections based on a completely static configuration, mapping such predetermined hashes to particular attack tools.

The second classification mechanism 142 may utilize the normalized query template 144. The first classification mechanism 140, however, may also utilize the normalized query template 144. The normalized query template 144 allows the first classification mechanism 140, for example, to match certain fragments of the database query 60 in a more reliable manner. The cybersecurity detection prediction service 40, and/or the morphological query analysis 120, may thus convert or transform the database query 60 into the normalized query template 144. The transformation or conversion of turning the database query 60 into the normalized query template 144 may involve replacing filter values (as specified in the background section) in atomic query filters with placeholders of the associated data type (e.g., an underscore for a string, 0 for numbers), e.g., (samAccountName=Joe) would be turned into (samAccountName=_). Depending on the subject domain, the morphological query analysis 120 may transform all fields, or for all data types, or only for some fields or some data types. In the LDAP case, for example, experimental testing shows that doing so for all string fields is the right balance, but different data domains may require different setups.

In data query interfaces where composite filters are supported (most of them are, including SQL and LDAP), this alternation typically requires parsing the filter into an object form, commonly a tree of some sort, then traversing over it down to the leaves (=atomic query filters), fixing up the values as discussed, and, at last, serializing it back to its protocol form. For example, a SQL WHERE clause like
WHERE DisplayName LIKE “A %” OR Age >30,
   may be turned into
WHERE DisplayName LIKE “______%” OR Age >______.

For a simple equality atomic filter (fieldname=fieldvalue), templating is straightforward, simply turning the field-value element into a static placeholder. Some data types, however (such as derived from the value or the atomic query filter operator), may require non-static replacement types: for example, the morphological query analysis 120 may generate an anonymized SQL LIKE pattern to retain the pattern form (and thus intent), e.g., “Foo %” (=starts with Foo) may be turned into “______%” (starts with some string).

Additional interface-specific accommodations may be applied. For example, list-type values (e.g., as used in SQL's IN) may require additional canonization in order to have a useful generic form (a fixed number of elements in the template is practical). Similarly, because in LDAP filters a composite OR filter is very often used to mimic SQL's IN functionality, experimental testing shows deduplicating of nested query filters is required.

Depending on the data domain the other query dimensions may also need some normalization as part of the templating process. For example, if field names are case insensitive, normalizing their case in the projection may be beneficial.

The cybersecurity detection prediction service 40 improves computer functioning. The cybersecurity detection prediction service 40 detects/predicts evidence of the cybersecurity attack 62. The cybersecurity detection prediction service 40 may then immediately instruct the endpoint cybersecurity agent 108 and/or the operating system 104 to block the hardware and software events representing the database query 60 and/or the endpoint cybersecurity detection 28. The endpoint cybersecurity agent 108, for example, may prevent the cybersecurity attack 62 from accessing the memory device 106 (e.g., RAM, ROM, disk). The endpoint cybersecurity agent 108 may also instruct the operating system 104 to halt or terminate current event behavior that is queued for execution by the operating system 104 and/or by a software application. The endpoint cybersecurity agent 108 may thus reactively or proactively stop the cybersecurity attack 62.

The cybersecurity detection prediction service 40 again provides an elegant solution. The cybersecurity detection prediction service 40 may log massive amounts of detailed information describing the database queries 60 and the endpoint cybersecurity detections 28. Simply put, the cybersecurity detection prediction service 40 reveals detailed information describing individual users, their client computer systems/machines, their corresponding network details, their corresponding database queries 60, and their corresponding endpoint cybersecurity detections 28. The cybersecurity detection prediction service 40 may search query logs for very specific query criteria and identify/retrieve the corresponding database entries. The cybersecurity detection prediction service 40 may thus classify those database queries 60 and lookup/find those database queries 60 which match a query parameter (such as the database query signature/GUID 128/130).

The cybersecurity detection prediction service 40 may anonymize. An interesting query example may reveal names of all the users in the systems, or perhaps just privileged users. In order to do that, for example, the cybersecurity detection prediction service 40 may remove all user data from the database query 60, such that only the shape of the database query 60 is known. The database query 60, for example, may specify “username=______” such that all database queries 60 of this kind have the same shape and may be treated the same way. The cybersecurity detection prediction service 40 may internally anonymize the database query 60, such that all customer/user data is removed, and leaving just the shape of the database query 60. The cybersecurity detection prediction service 40 may further have a list of common database queries (e.g., full queries and/or part of the queries), and the cybersecurity detection prediction service 40 may check/match if the common database queries appear within the database query 60. If the database query 60, for example, is a simple example of a username=“something,” then the cybersecurity detection prediction service 40 may tag the query as a query that fetches information about a specific user (e.g., a single user query). The database query 60, of course, may be more complex. The cybersecurity detection prediction service 40 is a flexible mechanism that can reveal multiple criteria matching various parts of the database query 60.

The cybersecurity detection prediction service 40 may also reveal the cybersecurity attack 62. There are many targeted attack tools used to attempt the cybersecurity attack 62. The cybersecurity detection prediction service 40 may thus annotate or enrich the database query 60 by generating the database query signature/GUID 128/130. By revealing the database query 60 and its corresponding endpoint cybersecurity detections 28, for example, the cybersecurity detection prediction service 40 may identify the cybersecurity malicious attack tool used in attack 62 (such as, for example, a METASPLOIT® vulnerability or some other attack tool). Query logs may thus be queried for specific attack signatures (such as the query signature/GUID 128/130) and reveal the specific attack tool.

Human resources provide more examples. Some cybercriminals attempt to hack human resource databases that store sensitive personnel information (such as data fields describing first name, last name, title, salary, home address, a location, tenure, promotion dates, and others). The HR database may be queried (e.g., the database query 60) for a particular name, and the employee's personal information may be retrieved. The HR database may again be queried for a different name, and that employee's personal information may be retrieved. The HR database may be queried many times for many employees' personal information. Each time, though, the endpoint cybersecurity agent 108 may forward/send each database query 60 to the cloud computing environment 22 for logging and analysis. Even though each database query 60 may be slightly different, though, the cybersecurity detection prediction service 40 determines that each database query 60 specifies an employee name. The cybersecurity detection prediction service 40 inspects each database query 60 and detects a name in a field. The cybersecurity detection prediction service 40 may thus create an anonymous or generic copy version of each database query 60. The cybersecurity detection prediction service 40, for example, has a morphological engine (such as the morphological query analysis 120) that may anonymize the database queries 60 (such as employeename=______). The cybersecurity detection prediction service 40 may then bundle or group all of the database queries 60 together.

The cybersecurity detection prediction service 40 may then reveal the client device 30. Once the cybersecurity detection prediction service 40 groups database queries 60 together, the cybersecurity detection prediction service 40 may detect that the same or common client device 30 is issuing multiple database queries 60. So, if a malicious threat actor has accessed the HR database and issued suspicious database queries 60 (such as requesting the salary field of all employees), the cybersecurity detection prediction service 40 may use the query logs to identify that specific morphological structure (e.g., suspicious queries for salary fields). The cybersecurity detection prediction service 40 thus reveals suspicious heuristics (such as the user of the client device 30 repeatedly querying for the salary fields of employees or salary enumeration). Those database queries 60 have the specific query signature/GUID 128/130 that the cybersecurity detection prediction service 40 will detect.

The LDAP query 90 may be even more revealing. An active directory database service may have many data fields describing active directory objects. These data fields may include security aspects, password policies, organizational trust schemes, and many other relationships. The cybersecurity detection prediction service 40 may thus harness and utilize vast knowledge repositories of active directory attacks (such as, for example, a Kerberoasting attack targeting active directories). The cybersecurity detection prediction service 40, for example, may thus monitor for an attacker that attempts to enumerate SPN service principle names as a precursor to a Kerberoasting attack. By logging the database queries 60, though, the cybersecurity detection prediction service 40 has that specific query signature/GUID 128/130 that an SPN enumeration was previously requested. The cybersecurity detection prediction service 40 may thus create the detection for and/or feed into the machine learning model 52.

The morphological query analysis 120 is thus a very elegant scheme that improves computer functioning. The database queries 60 may be grouped together based on their query shape. Information may be removed from the database queries 60 which, first, helps just for anonymization, but, second, also helps create structure. Instead of seeing queries as different, the database queries 60 may be grouped together to create common queries that are maybe benign or malicious. The morphological query analysis 120 may further add additional annotations to the database queries 60.

The cybersecurity detection prediction service 40 may detect suspicious database queries 60 for a database schema. The cybersecurity detection prediction service 40 may, or may not, may have knowledge of the schema of the database. The cybersecurity detection prediction service 40 need not have knowledge of the benign usages of the database. The cybersecurity detection prediction service 40 may be applied to an identity and/or access database. The cybersecurity detection prediction service 40 may be applied to SQL, MONGO®, ELASTIC®, LDAP, and other database products and frameworks.

More computer functioning is greatly improved. The malicious use of the database queries 60, along with the malicious cybersecurity event signatures 112, may be used to harm computer and network operations. The cybersecurity detection prediction service 40, though, quickly identifies these suspicious/maliciousness operations 54 to minimize or even prevent damage to the client device 30. Indeed, because the cybersecurity detection prediction service 40 may utilize the machine learning model 52, the cybersecurity detection prediction service 40 is very fast and very simple to execute. The cybersecurity detection prediction service 40 need merely compare the current hardware/software events to the ranges referenced by the cybersecurity assessment profile 50. The cybersecurity assessment profile 50 consumes little space (in bits/bytes) in the memory device 46. Moreover, because comparisons may be simple logical statements, the hardware processor 42 requires less cycles and less time to classify the cybersecurity attack 62. Computer resources are reduced, and less electrical power is required to test for presence of the cybersecurity attack 62. The cybersecurity detection prediction service 40 is thus very fast and very simple, allowing the cloud computing environment 22 to quickly assess millions of database queries 60 and hardware/software events reported each day or week. The cybersecurity detection prediction service 40 thus greatly improves the computer functioning of the server 24 when detecting the cybersecurity attack 62.

Client computer functioning is also greatly improved. The cybersecurity detection prediction service 40 greatly improves the computer functioning of the client device 30 and other client computer systems. The cybersecurity detection prediction service 40 allows the endpoint cybersecurity agent 108 to stop the cybersecurity attack 62 before damage is done. Because the endpoint cybersecurity agent 108 receives the event notifications 110 from the operating system 104, the endpoint cybersecurity agent 108 has advanced notice, or early warning, of the cybersecurity attack 62. The endpoint cybersecurity agent 108 may thus confer with the cloud computing environment 22 for confirmation of the cybersecurity attack 62. The endpoint cybersecurity agent 108 may then block/stop/halt the malicious events to prevent degraded computer performance, network intrusion, or other cybersecurity attack 62.

The machine learning model 52 is trained. The cybersecurity detection prediction service 40, in particular, provides a cybersecurity solution to flag novel reconnaissance queries (such as the database/SQL/LDAP query 60/80/90) that is also able to distinguish malicious from benign. Indeed, cybersecurity service providers have observed patterns of threat actors starting off with LDAP reconnaissance before moving laterally across endpoints in a network. The cybersecurity detection prediction service 40 may thus monitor for the endpoint cybersecurity detections 28 (such as the signature match with the cybersecurity event signature 112) that correlate with the database/SQL/LDAP queries 60/80/90 within the same timeframe 64 for that same user. The cybersecurity detection prediction service 40 may thus implement logical rules and/or the machine learning to categorically label the database/SQL/LDAP query 60/80/90 which correlated with the endpoint cybersecurity detections 28 for the same user within the timeframe 64. The cybersecurity detection prediction service 40, for example, may thus query for and retrieve requests for the LDAP queries 90 at the domain controller level as well as endpoint cybersecurity detection events from the endpoint cybersecurity agent 108, joining and labeling the two based on source endpoint and time proximity. The cybersecurity detection prediction service 40 may further join and label using software process identifiers and time proximity. The basic join logic maps the source endpoint account object of each LDAP query 90 to its endpoint cybersecurity agent 108 using an intermediary host table. After mapping and joining LDAP queries 90 to endpoint cybersecurity detections 28 by the endpoint cybersecurity agent 108, the cybersecurity detection prediction service 40 may filter to less common queries for each respective customer and label the queries as the suspicious/malicious operation 54 if they fall within the timeframe 64 (e.g., an hour) before or after a high efficacy endpoint cybersecurity detection 28. These labels feed into the machine learning model 52 (such as a supervised machine learning classifier) that extrapolates query and user patterns to detect suspicious LDAP queries 90. The machine learning model 52 is trained on a large corpus sample of LDAP queries 90 to identify novel and suspicious LDAP query signatures 128/130. Signatures represent unique rules or patterns that certain suspected malicious LDAP queries 90 meet. If an LDAP query 90 meets all the conditions in a signature 128/130, the LDAP query 90 is flagged as the suspicious/malicious operation 54. Indeed, testing used two (2) different sets of signatures. One set was based on the obfuscated LDAP query 90, its attributes, the search scope, and size limit. The main set of signatures was based on the above plus encryption type, authentication method, and source entity roles.

The machine learning model 52 may be trained using suspicious data. The machine learning model 52, for example, may be trained using a corpus of suspicious endpoint cybersecurity detection 28. The machine learning model 52 may additionally or alternatively be trained using a corpus of suspicious database queries 60. The cybersecurity detection prediction service 40 may filter down to the suspicious database queries 60, such as the database queries 60 that were executed by users on a specific customer/user/identifier (such as during or over a period of time, for example, 14 days). The cybersecurity detection prediction service 40 may inspect/monitor unique database queries 60 to that customer/user/CID identifier. Indeed, uncommon or even rare database queries 60 may be suspicious. The cybersecurity detection prediction service 40 may then label the database queries 60 as suspicious/malicious operation 54 or as normal/benign operation 56 (perhaps a binary 1/0) when logged/observed with the endpoint cybersecurity detection 28 within a time proximity. The cybersecurity detection prediction service 40 may thus label the database queries 60 as suspicious/malicious operation 54 if they overlap with the endpoint cybersecurity detections 28 within the timeframe 64.

The cybersecurity detection prediction service 40 may thus correlate the endpoint cybersecurity detections 28 with client activity or behavior. The client activity or behavior, for example, may be the database queries 60. The client activity or behavior, however, may be active directory (AD) action or identity action. The client activity or behavior, as another example, may be client/service/network logins (such as logins via active directory). The cybersecurity detection prediction service 40 may thus correlate those client activities or behaviors (such as client/service/network logins) with the endpoint cybersecurity detections 28 within the timeframe 64.

The endpoint cybersecurity agent 108 may reveal the database queries 60 and the endpoint cybersecurity detections 28. The endpoint cybersecurity agent 108, for example, may be installed to the client devices 30 to monitor their activities and behaviors. The endpoint cybersecurity agent 108 may be associated with a unique agent identifier that also uniquely identifies each database query 60 and each endpoint cybersecurity detection 28. The cybersecurity detection prediction service 40 may thus associate the signature/GUID 128/130 and the unique agent identifier to track each database query 60 and each endpoint cybersecurity detection 28. The cybersecurity detection prediction service 40 may thus utilize dataset jointing techniques to monitor the source endpoint that executed the LDAP query 90 and to monitor the endpoint that triggered the endpoint cybersecurity detection 28. The cybersecurity detection prediction service 40 may thus join based on the unique agent identifier and the source machine object signature/GUID 128/130.

The cybersecurity detection prediction service 40 may further monitor role play. Entity data may be used to further predict whether activities/behavior are suspicious/malicious operation 54 or normal/benign operation 56. The role of the user issuing the database query 60, for example, may help distinguish, or predict, suspicious/malicious operation 54. An administrative role (such as a domain controller role, or a DNS server role, or an administrative user) may determine the user's privileges. Some database queries 60 associated with administrative privileges may be less suspicious than no privileges. These role-based correlations may be influential to predicting malicious or benign.

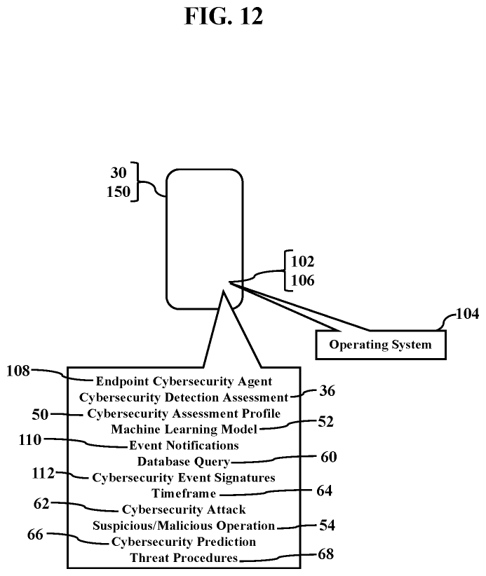

FIG. 12 illustrates some examples of localized analysis. Here the endpoint cybersecurity agent 108 may locally execute the fast and effective cybersecurity detection assessment 36. That is, the endpoint cybersecurity agent 108 may coordinate a download of the cybersecurity assessment profile 50 (perhaps via the cloud computing environment 22 illustrated in FIGS. 1-7 & 9) to the client's memory device 106. While the client device 30 may be any processor-controlled computer system, FIG. 12 illustrates a mobile smartphone 150. The cybersecurity assessment profile 50 may still be generated by the machine learning model 52, but the machine learning model 52 may be a local or cloud-based resource. So, when the operating system 104 alerts the endpoint cybersecurity agent 108 (such as via the event notifications 110) of the database query 60, the endpoint cybersecurity agent 108 may log the database query 60 and its query timestamp.

Moreover, as the operating system 104 further alerts the endpoint cybersecurity agent 108 (such as via the event notifications 110) of requested hardware/software events, the endpoint cybersecurity agent 108 may instruct the mobile smartphone 150 and/or the hardware processor 102 to compare the database query 60 and/or the events to the cybersecurity assessment profile 50 locally stored in its memory device 106. The cybersecurity assessment profile 50 again describes the database queries 60, the cybersecurity event signatures 112, and/or the timeframes 64 that indicate the cybersecurity attack 62. If the smartphone's behavior or activities equals, matches, satisfies, lies within, or conforms to the cybersecurity assessment profile 50, then the endpoint cybersecurity agent 108 may determine that the smartphone's behavior or activities represents the suspicious/malicious operation 54. That is, the cybersecurity assessment profile 50 reveals that the smartphone's behavior or activities is actual evidence of the cybersecurity attack 62. The endpoint cybersecurity agent 108 may generate the cybersecurity prediction 66 as an output, and the cybersecurity prediction 66 determines, or predicts, that the mobile smartphone 150 is being used to conduct the cybersecurity attack 62. The endpoint cybersecurity agent 108 may implement the threat procedures 68, such as notification/quarantine/isolation/halt or other urgent operations. The endpoint cybersecurity agent 108 may block/drop/halt events associated with the cybersecurity attack 62 (such as the database query 60 and/or the cybersecurity event signature 112). The endpoint cybersecurity agent 108 may recommend, or even instruct, the operating system 104 to halt, stop, ignore, drop, or otherwise prevent the events representing the cybersecurity attack 62. The endpoint cybersecurity agent 108 thus prevents the cybersecurity attack 62 so that no damage is done.

The endpoint cybersecurity agent 108 improves computer functioning. The endpoint cybersecurity agent 108 detects/predicts evidence of the cybersecurity attack 62. Because the endpoint cybersecurity agent 108 detects the cybersecurity attack 62, the endpoint cybersecurity agent 108 may immediately initiate or implement the threat procedures 68. The endpoint cybersecurity agent 108, for example, may prevent the cybersecurity attack 62 from accessing the memory device 106 (e.g., RAM, ROM, disk). The endpoint cybersecurity agent 108 may also instruct the operating system 104 to halt or terminate current events, behaviors, and/or activities that are queued for execution by the operating system 104 and/or by a software application. The endpoint cybersecurity agent 108 may thus reactively or proactively stop the cybersecurity attack 62.

The endpoint cybersecurity agent 108 further improves computer functioning. The endpoint cybersecurity agent 108 detects evidence of the cybersecurity attack 62 without a constant, active network connection. That is, once the endpoint cybersecurity agent 108 obtains the cybersecurity assessment profile 50, the endpoint cybersecurity agent 108 may protect the client device/smartphone 30/150 without requiring further network communications. The endpoint cybersecurity agent 108, in other words, provides the cybersecurity detection assessment 36, and the detection prediction service 40, independent of a constant, active network connection to the Internet or other network. The endpoint cybersecurity agent 108 only needs an intermittent or periodic (e.g., hourly, daily, or other timing) Internet connection to receive the cybersecurity assessment profile 50. Once the cybersecurity assessment profile 50 is obtained, the endpoint cybersecurity agent 108 may implement offline operation and locally monitor the client device/smartphone 30/150 for predictive evidence of the cybersecurity attack 62. Cloud-based services are greatly reduced, network bandwidth is greatly reduced, and network traffic is greatly reduced. The endpoint cybersecurity agent 108 may thus be a predominantly local detection prediction service 40.

The endpoint cybersecurity agent 108 further improves computer functioning. Because the endpoint cybersecurity agent 108 need only perform operations for locally monitoring, generating, and comparing, these operations may thus be represented using simple logical statements or code modules that consume little space (e.g., bits/bytes) in the memory device 106. These operations further require fewer hardware processor cycles and fewer input/output/read/write operations. These operations also consume reduced electrical power. The endpoint cybersecurity agent 108 is thus a compact, lightweight solution that is easily deployed to clients/customers in the field (such as the client device/smartphone 30/150). Indeed, because the endpoint cybersecurity agent 108 requires much less hardware and software resources, the endpoint cybersecurity agent 108 is an ideal solution for so-called Internet of Things devices having limited processor, memory, networking, and other resources.

The endpoint cybersecurity agent 108 interfaces with the operating system 104. The endpoint cybersecurity agent 108 may have kernel-mode components having kernel-level permissions to a kernel mode. The endpoint cybersecurity agent 108 may also have user-mode components in a user mode. The endpoint cybersecurity agent 108 may load before the operating system 104, perhaps very early in the boot-time of the client device 30. The endpoint cybersecurity agent 108 may thus be installed as a kernel-level driver and may be received from the cloud computing environment 22. Because the endpoint cybersecurity agent 108 may have the kernel-mode components having kernel-level permissions to the kernel mode, the endpoint cybersecurity agent 108 has kernel-level permissions to establish the event notifications 110 from the operating system 104 and/or from a software application. The endpoint cybersecurity agent 108 may thus instrument, monitor, and/or intercept event behaviors (such as events, messages, function calls, system calls, or other activities) in the kernel mode. Moreover, because the endpoint cybersecurity agent 108 may also have the user-mode components, the endpoint cybersecurity agent 108 may also instrument, monitor, and/or intercept event behaviors (such as events, messages, function calls, system calls, APIs, or other activities) in the user mode.

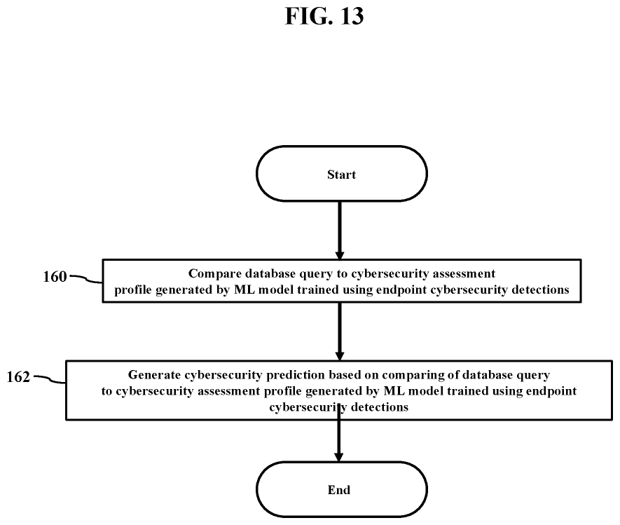

FIG. 13 illustrates examples of a method or operations executed by the computer system 20 or the client device 30 that assesses the database query 60. The database query 60 is compared to the cybersecurity assessment profile 50 generated by the machine learning model 56 trained using the endpoint cybersecurity detections 28 (Block 160). The cybersecurity prediction 66 is generated based on the comparing of the database query 60 to the cybersecurity assessment profile 50 generated by the machine learning model 56 trained using the endpoint cybersecurity detections 28 (Block 162).

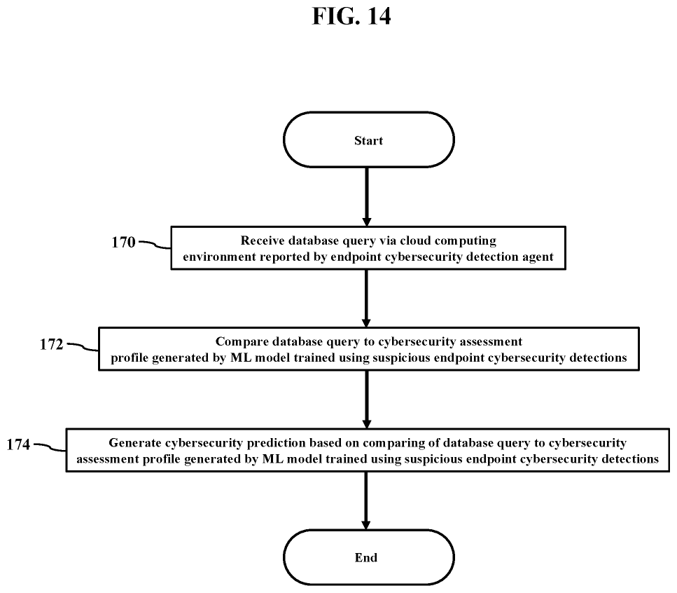

FIG. 14 illustrates more examples of a method or operations for assessing the database query 60. The database query 60 is received via the cloud computing environment 22 that was reported by the endpoint cybersecurity detection agent 108 (Block 170). The database query 60 is compared to the cybersecurity assessment profile 50 generated by the machine learning model 56 trained using the suspicious endpoint cybersecurity detections 28 (Block 172). The cybersecurity prediction 66 is generated based on the comparing of the database query 60 to the cybersecurity assessment profile 50 generated by the machine learning model 56 trained using the suspicious endpoint cybersecurity detections 28 (Block 174).

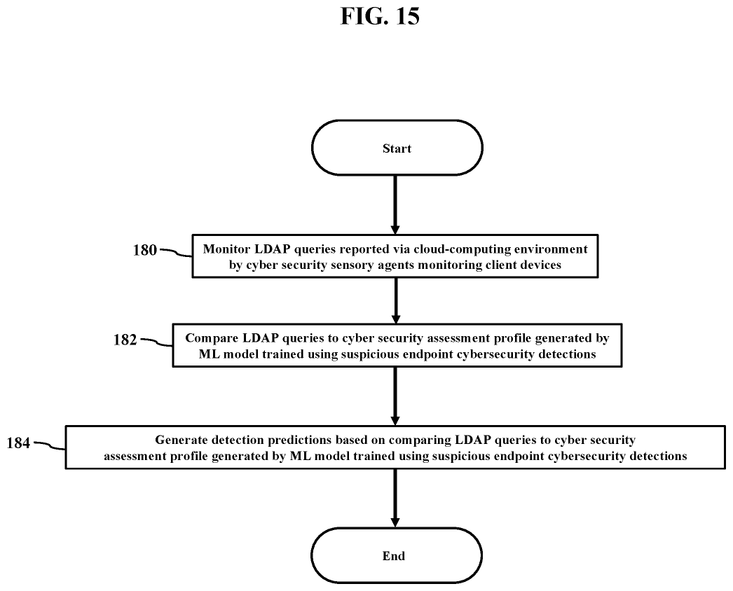

FIG. 15 illustrates still more examples of a method or operations for assessing the lightweight directory access protocol (LDAP) query 90. The LDAP queries 90 are monitored that were reported via the cloud computing environment 22 by the endpoint cybersecurity detection agents 108 monitoring the client devices 30 (Block 180). The LDAP queries 90 are compared to the cybersecurity assessment profile 50 generated by the machine learning model 56 trained using the suspicious endpoint cybersecurity detections 28 (Block 182). The cybersecurity predictions 66 are generated based on the comparing of the LDAP queries 90 to the cybersecurity assessment profile 50 generated by the machine learning model 56 trained using the suspicious endpoint cybersecurity detections 28 (Block 184).

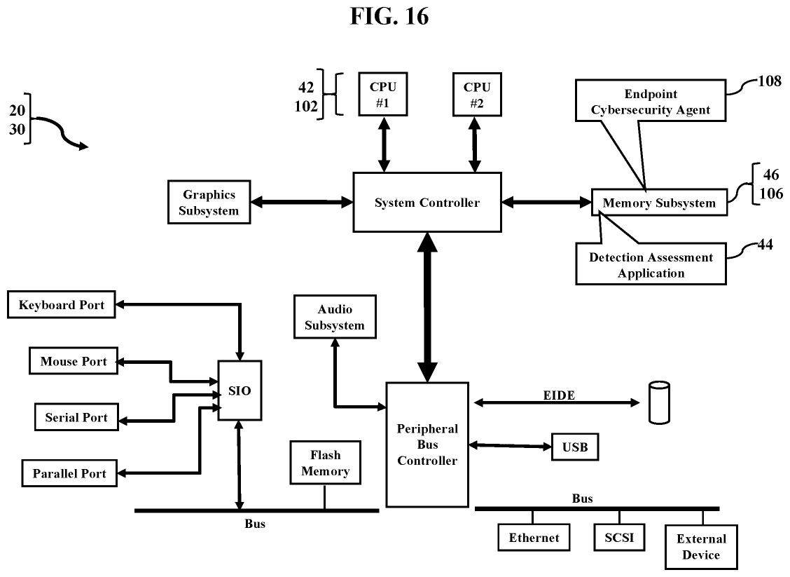

FIG. 16 illustrates a more detailed example of the operating environment. FIG. 16 is a more detailed block diagram illustrating the computer system 20 and/or the client device 30. The detection assessment application 44, and/or the endpoint cybersecurity agent 108, is stored in the memory subsystem or device 46/106. One or more of the hardware processors 42/102 communicate with the memory subsystem or device 46/106 and execute the detection assessment application 44 and/or the endpoint cybersecurity agent 108. Examples of the memory subsystem or device 46/106 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. Because the computer system 20 and/or the client device 30 is known to those of ordinary skill in the art, no detailed explanation is needed.

The computer system 20 and/or the client device 30 may have any embodiment. This disclosure mostly discusses the computer system 20 as the server 24 and the client device 30 as the smartphone 150. The cybersecurity detection prediction service 40, however, may be easily adapted to any stationary or mobile computing, such as a laptop, a tablet computer, a smartwatch, and a network switch/router. The cybersecurity detection prediction service 40 may also be easily adapted to other embodiments of smart devices, such as a television, an audio device, a remote control, and a recorder. The cybersecurity detection prediction service 40 may also be easily adapted to still more smart appliances, such as washers, dryers, and refrigerators. Indeed, as cars, trucks, and other vehicles grow in electronic usage and in processing power, the cybersecurity detection prediction service 40 may be easily incorporated into any vehicular controller.

The above examples of the cybersecurity detection prediction service 40 may be applied regardless of the networking environment. The cybersecurity detection prediction service 40 may be easily adapted to stationary or mobile devices having wide-area networking (e.g., 4G/LTE/5G cellular), wireless local area networking (WI-FI®), near field, and/or BLUETOOTH® capability. The cybersecurity detection prediction service 40 may be applied to stationary or mobile devices utilizing any portion of the electromagnetic spectrum and any signaling standard (such as the IEEE 802 family of standards, GSM/CDMA/TDMA or any cellular standard, and/or the ISM band). The cybersecurity detection prediction service 40, however, may be applied to any processor-controlled device operating in the radio-frequency domain and/or the Internet Protocol (IP) domain. The cybersecurity detection prediction service 40 may be applied to any processor-controlled device utilizing a distributed computing network, such as the Internet (sometimes alternatively known as the “World Wide Web”), an intranet, a local-area network (LAN), and/or a wide-area network (WAN). The cybersecurity detection prediction service 40 may be applied to any processor-controlled device utilizing power line technologies, in which signals are communicated via electrical wiring. Indeed, the many examples may be applied regardless of physical componentry, physical configuration, or communications standard(s).

The cybersecurity detection prediction service 40 may utilize any processing component, configuration, or system. For example, the cybersecurity detection prediction service 40 may be easily adapted to any desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or any other manufacturer. The cybersecurity detection prediction service 40 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The cybersecurity detection prediction service 40 may use packetized communications. When the computer system 20 and/or the client device 30 communicates via the cloud computing environment 22, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The cybersecurity detection prediction service 40 may utilize any signaling standard. The computer system 20, the client device 30, and the cloud computing environment 22 may mostly use wired networks to interconnect network members. However, the computer system 20, the client device 30, and the cloud computing environment 22 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cybersecurity detection prediction service 40 may also utilize other standards, such as the I.E.E.E. 802 family of standards, the Industrial, Scientific, and Medical band of the electromagnetic spectrum, BLUETOOTH®, low-power or near-field, and any other standard or value.

The cybersecurity detection prediction service 40 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for providing the cybersecurity detection prediction service 40, as the above paragraphs explain.

The diagrams, schematics, illustrations, and the like represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that assesses a database query, comprising:
comparing, by the computer system, the database query to a cybersecurity assessment profile generated by a machine learning model trained using endpoint cybersecurity detections; and
generating, by the computer system, a cybersecurity prediction associated with the database query based on the comparing of the database query to the cybersecurity assessment profile generated by the machine learning model trained using the endpoint cybersecurity detections.

2. The method of claim 1, further comprising determining that the database query occurs within a timeframe associated with any of the endpoint cybersecurity detections.

3. The method of claim 1, further comprising determining that the database query conforms to the cybersecurity assessment profile generated by the machine learning model trained using the endpoint cybersecurity detections.

4. The method of claim 1, further comprising determining that the database query fails to conform to the cybersecurity assessment profile generated by the machine learning model trained using the endpoint cybersecurity detections.

5. The method of claim 1, further comprising determining that the database query is suspicious operation based on the cybersecurity assessment profile generated by the machine learning model trained using the endpoint cybersecurity detections.

6. The method of claim 1, further comprising predicting a cybersecurity attack based on the comparing of the database query to the cybersecurity assessment profile generated by the machine learning model trained using the endpoint cybersecurity detections.

7. The method of claim 1, further comprising determining a unique query signature associated with the database query.

8. At least one computer system that assesses a database query, comprising:
at least one central processing unit; and
at least one memory device storing instructions that, when executed by the at least one central processing unit, perform operations, the operations comprising:
receiving the database query reported via a cloud computing environment by an endpoint cybersecurity detection agent;
comparing the database query to a cybersecurity assessment profile generated by a machine learning model trained using suspicious endpoint cybersecurity detections; and
generating a cybersecurity prediction associated with the database query based on the comparing of the database query to the cybersecurity assessment profile generated by the machine learning model trained using the suspicious endpoint cybersecurity detections.

9. The at least one computer system of claim 8, wherein the operations further comprise determining that the database query occurs within a timeframe associated with any of the suspicious endpoint cybersecurity detections.

10. The at least one computer system of claim 8, wherein the operations further comprise determining that the database query conforms to the cybersecurity assessment profile generated by the machine learning model trained using the suspicious endpoint cybersecurity detections.

11. The at least one computer system of claim 8, wherein the operations further comprise determining that the database query fails to conform to the cybersecurity assessment profile generated by the machine learning model trained using the suspicious endpoint cybersecurity detections.

12. The at least one computer system of claim 8, wherein the operations further comprise determining that the database query is suspicious operation based on the cybersecurity assessment profile generated by the machine learning model trained using the suspicious endpoint cybersecurity detections.

13. The at least one computer system of claim 8, wherein the operations further comprise predicting a cybersecurity attack based on the comparing of the database query to the cybersecurity assessment profile generated by the machine learning model trained using the suspicious endpoint cybersecurity detections.

14. The at least one computer system of claim 8, wherein the operations further comprise determining a unique query signature associated with the database query.

15. A memory device storing instructions that, when executed by a central processing unit, perform operations, comprising:
monitoring lightweight directory access protocol (LDAP) queries reported via a cloud computing environment by endpoint cybersecurity detection agents monitoring client devices;
comparing the LDAP queries to a cybersecurity assessment profile generated by a machine learning model trained using suspicious endpoint cybersecurity detections; and
generating cybersecurity predictions associated with the LDAP queries based on the comparing of the LDAP queries to the cybersecurity assessment profile generated by the machine learning model trained using the suspicious endpoint cybersecurity detections.

16. The memory device of claim 15, wherein the operations further comprise determining that an LDAP query of the LDAP queries occurs within a timeframe associated with a suspicious endpoint cybersecurity detection of the suspicious endpoint cybersecurity detections.

17. The memory device of claim 15, wherein the operations further comprise determining that an LDAP query of the LDAP queries conforms to the cybersecurity assessment profile generated by the machine learning model trained using the suspicious endpoint cybersecurity detections.

18. The memory device of claim 15, wherein the operations further comprise determining that an LDAP query of the LDAP queries fails to conform to the cybersecurity assessment profile generated by the machine learning model trained using the suspicious endpoint cybersecurity detections.

19. The memory device of claim 15, wherein the operations further comprise determining that an LDAP query of the LDAP queries is suspicious operation based on the cybersecurity assessment profile generated by the machine learning model trained using the suspicious endpoint cybersecurity detections.

20. The memory device of claim 15, wherein the operations further comprise predicting a cybersecurity attack based on the comparing of the LDAP queries to the cybersecurity assessment profile generated by the machine learning model trained using the suspicious endpoint cybersecurity detections.
